(19) United States
(12) Patent Application Publication
(10) Pub. No.: US 2017/0213577 A1
(43) Pub. Date: Jul. 27, 2017

(54) DEVICE FOR GENERATING A VIDEO OUTPUT DATA STREAM, VIDEO SOURCE, VIDEO SYSTEM AND METHOD FOR GENERATING A VIDEO OUTPUT DATA STREAM AND A VIDEO SOURCE DATA STREAM

(71) Applicant: Fraunhofer-Gesellschaft zur Foerderung der angewandten Forschung e.V., Munich (DE)

(72) Inventors: Eugen WAGNER, Erlangen (DE); Christopher SALOMAN, Stegaurach (DE); Wolfgang THIEME, Schwaig (DE)

(21) Appl. No.: 15/481,755

(22) Filed: Apr. 7, 2017

Related U.S. Application Data
(63) Continuation of application No. PCT/EP2015/068480, filed on Aug. 11, 2015.

(30) Foreign Application Priority Data
Oct. 8, 2014 (DE) 102014220423.2

(51) Int. Cl. G11B 27/038; H04N 9/64; H04N 9/76; H04N 5/268; H04N 9/75; H04N 5/265; H04N 5/272

(52) U.S. Cl. CPC G11B 27/038; H04N 5/265; H04N 9/643; H04N 5/272; H04N 5/268; H04N 9/75; H04N 9/76

(57) ABSTRACT

A device for generating a video output data stream has a first and a second signal input for receiving a first and a second video source data stream, a processor configured to provide the video output data stream based on the first video source data stream at a first point in time and, by means of a switching process, based on the second video source data stream at a second point in time which follows the first point in time. In addition, the device has a control signal output for transmitting a control command to a video source from which the first or second video source data stream is received. The control command has an instruction to the video source for applying a transition effect which is temporally located between an image of the first and an image of the second video source data stream in the video output signal.

### CROSS-REFERENCE TO RELATED APPLICATIONS

This application is a continuation of copending International Application No. PCT/EP2015/068480, filed Aug. 11, 2015, which is incorporated herein by reference in its entirety, and additionally claims priority from German Application No. 102014220423.2, filed Oct. 8, 2014, which is also incorporated herein by reference in its entirety.

### BACKGROUND OF THE INVENTION

The present invention relates to a device for generating a video output data stream, like a video mixer, to a video source, to a video system and to a method for generating a video output data stream and a video source data stream. In addition, the invention relates to a computer program and to a distributed production of special video effects in a live-capable video production system comprising several cameras.

The workflow of a live video production comprising several cameras may be described in a simplified manner in that the video streams of the cameras are transferred to the video mixer in real time. The director decides which of the cameras is transmitting, that is switched to be “on air”. Then, the video stream may be provided with fade-overs, like logos, graphics or texts. After that, the output stream is encoded and made available to the consumers via a network (for example the Internet, satellite or cable).

When switching between cameras, transition effects are frequently used. Adding transition effects in real time is supported by many video mixers on the market. However, these are mostly high-priced apparatuses. These comprise inputs for uncompressed video signals and network interfaces for an Internet protocol (IP)-based transfer of compressed video streams. Encoded video data received are at first decoded. Mixing takes place on the basis of uncompressed video data which are subsequently encoded again. This approach implies high requirements to the hardware of the video mixer and, thus, its price.

For many cheap live productions, in particular when done by semi-professionals or amateurs, a small number of functions which a video mixer is to provide is sufficient. In case several cameras are used for the production, an important, or the most important, function is easy switching between the cameras. When switching may be implemented in a creative manner using simple means, the quality aspect of the broadcast is increased considerably.

A dedicated hardware video mixer decodes the ingoing video streams of cameras connected, calculates video effects and encodes the resulting video stream or passes the output stream on to a separate encoder. Among the advantages of such a solution are a wide range of functions, very good performance and a way of combining encoded and non-encoded video sources. In addition, this solution is a constituent part of established workflows. Among the disadvantages are complex operation, high price, limited mobility of the device and high calculating complexity to be performed by the video mixer.

There are software video mixers running on conventional personal computers (PCs). Their range of function is similar to that of dedicated hardware video mixers and is limited by the hardware resources of the PC used.

There are also software solutions for mobile apparatuses, like mobile phones or tablet computers serving as live video mixers. For example, the software connects four mobile apparatuses to form a group and has the encoded video streams transferred live from the apparatuses acting as “camera” to the “director” apparatus, the video mixer. The director apparatus controls switching between the video streams. The software allows adding fade-over effects when switching between the cameras. The output video is merged offline after having finished recording. Thus, step marks having been generated by the “director” during recording are used. Generating fade-over effects necessitates decoding and encoding of parts of the recording.

Today, there are also cloud-based solutions. The cameras transfer encoded video streams to a server which has the resources necessitated for processing the data in real time. The director is granted access to the control elements, like preview of all the video/audio sources, cut, effects, etc., using a web interface. Among the advantages of such solutions is an increased scalability since the performance necessitated may be purchased additionally. In addition, the price for the server is lower than the costs for purchasing special hardware. However, quality features of the network connection, like the channel bandwidth available or potential transmission errors are critical here. This restricts the field of application of this solution.

[1] and [2] describe methods allowing generating transition effects directly on encoded video data, without having to decode same completely beforehand. Such methods reduce the complexity of video processing and reduce the requirements to the video mixer hardware.

Consequently, video mixers of low hardware requirements, like the computing performance necessitated or provided of a processor of the video mixer, would be desirable.

The object underlying the present invention is providing a live or real time-capable device for generating a video output data stream having transition effects, wherein the device here only necessitates a low computing performance so that the requirements to energy and/or computing performance are low.

### SUMMARY

According to an embodiment, a device for generating a video output data stream may have: a first signal input for receiving a first video source data stream; a second signal input for receiving a second video source data stream; processor means configured to provide the video output data stream based on the first video source data stream at a first point in time and, by means of a switching process, based on the second video source data stream at a second point in time which follows the first point in time; a control signal output for transmitting a control command to a video source from which the first or second video source data stream is received; wherein the control command has an instruction to the video source for applying a transition effect which is temporally located between an image of the first and an image of the second video source data stream in the video output signal, and wherein the video source data stream received from the video source has the transition effect at least partly; wherein the transition effect is a map, a fade-in effect, a fade-out effect or an effect for fading over a first image of the video source data stream by a second image of the video source data stream or by graphics stored in a graphics memory or received by the video source.

According to an embodiment, a video source configured to output a video source data stream may have: a signal input for receiving a control command from a device for generating a video output stream, which has an instruction for applying a transition effect to the video source data stream; wherein the instruction refers to at least one of a duration, a starting point in time, a final point in time, a type or intensity of the transition effect; wherein the video source is configured to implement the transition effect in the video source data stream based on the control command and to output a modified video source data stream; and wherein the transition effect is a map, a fade-in effect, a fade-out effect or an effect for fading over a first image of the video source data stream by a second image of the video source data stream or by graphics stored in a graphics memory or received by the video source; wherein the video source is configured to output the video source data stream based on an image sensor of the video source or retrieve same from a data storage of the video source.

According to still another embodiment, a video system may have: a device for generating a video output data stream as mentioned above; a first video source as mentioned above; and a second video source as mentioned above.

According to another embodiment, a method for generating a video output data stream may have the steps of: receiving a first video source data stream; receiving a second video source data stream; providing the video output data stream based on the first video source data stream at a first point in time and, by means of a switching process, based on the second video source data stream at a second point in time which follows the first point in time; transmitting a control command to the video source from which the first or second video source data stream is received; wherein the control command has an instruction to the video source for applying a transition effect to the first or second video source data stream, wherein the video source data stream received from the video source has the transition effect; and wherein the instruction relates to at least one of a duration, a starting point in time, a final point in time, a map, a type or intensity of the transition effect; and wherein the transition effect is a map, a fade-in effect, a fade-out effect or an effect for fading over a first image of the video source data stream by a second image of the video source data stream or by graphics stored in a graphics memory or received by the video source.

According to another embodiment, a method for outputting a video source data stream by a video source may have the steps of: providing the video source data stream based on an image sensor of the video source or based on retrieving from a data storage of the video source; receiving a control command having an instruction for applying a transition effect to the video source data stream; implementing the transition effect in the video source data stream based on the control command and outputting a modified video source data stream; wherein the instruction relates to at least one of a duration, a starting point in time, a final point in time, a map, a type or intensity of the transition effect; and wherein the transition effect is a map, a fade-in effect, a fade-out effect or an effect for fading over a first image of the video source data stream by a second image of the video source data stream or by graphics stored in a graphics memory or received by the video source.

Another embodiment may have a non-transitory digital storage medium having stored thereon a computer program for performing one of the methods as mentioned above when said program is run by a computer.

A central idea of the present invention is having recognized that the above object may be achieved by the fact that transition effects of the video output data stream, when switching between two video sources, are applied, that is realized, already by the video source so that a video output data stream including switching effects (transition effects) may be obtained by simply switching between video source data streams. This results in reduced calculating complexities on the part of the device for generating the video output data stream so that the technical requirements to the hardware are reduced, operation of the device is efficient, that is may be done by only a few calculations and at low an energy consumption, and/or an installation size in the device is reduced.

In accordance with an embodiment, a device for generating a video output data stream comprises a first and a second signal input for receiving a first and a second video source data stream. Furthermore, the device comprises processor means configured to provide the video output data stream based on the first video source data stream at a first point in time and, by means of a switching process, based on the second video source data stream at a second point in time which follows the first point in time. In addition, the device comprises a control signal output for transmitting a control command to a video source, the first or second video source data stream being received from the video source. The control command comprises an instruction to the video source for applying a transition effect to the video source data stream provided, or a sequence of images. The transition effect is temporally located between an image of the first and an image of the second video source data stream in the video output signal. Switching with no decoding, calculating and/or applying a transition effect or encoding the video source data stream received allows efficient operation of the device.

In accordance with another embodiment, the processor means is configured to process a program code in a time-synchronous manner with processor means of the video source, that is the device for generating a video output data stream is synchronized with one, several or all the video data sources. Of advantage with this embodiment is the fact that, based on a common time base for the device and video sources, an exact temporal positioning of the transition effect in the video output data stream is possible.

In accordance with another embodiment, the transition effect comprises a first sub-effect and a second sub-effect. The device is configured to transmit a first control command with a first instruction for applying the first sub-effect to the first video source and to transmit a control command with a second instruction for applying the second sub-effect to the second video source. Of advantage with this embodiment is the fact that implementing and calculating the transition effects or sub-transition effects may be performed in a distributed manner in the video sources so that the calculating complexities for the individual video sources are reduced. In addition, transition effects may be represented, that is are applicable, both before switching, like during fade-out, by the first video source and also after switching, like during fade-in, by the second video source.

In accordance with another embodiment, the device is configured to provide the first or second video source data stream including the transition effect as a video output data stream, without manipulating the first or second video source data stream. Of advantage with this embodiment is the fact that the device may be implemented like in a change-over switch, that is a splitter or switch, which may be connected between the video source data streams and that only a single video source data stream is passed on or provided as the video output data stream so that the video output data stream may be provided at a further reduced calculating complexity.

In accordance with another embodiment, a video source configured for outputting a video source data stream comprises a signal input for receiving a control command from a device for generating a video output data stream. The control command comprises an instruction for applying a transition effect to the video source data stream, wherein the instruction relates to at least one of a duration, a starting point in time, a final point in time, a mapping, a type or intensity of the transition effect. Of advantage with this embodiment is the fact that implementing the transition effect may take place already before encoding the video source data stream by the video source.

In accordance with another embodiment, the video source comprises processor means configured to process a program code in a time-synchronous manner with processing means of a device for generating a video output data stream.

In accordance with another embodiment, the video source is configured to apply the transition effect based on influencing the image signal processing chain or based on graphical processor means. Of advantage with this embodiment is the fact that the high calculating efficiency of graphical processor means may be used for implementing the transition effect.

Further embodiments provide a video system comprising a device for generating a video output data stream, a first and a second video source.

Further embodiments relate to a method for generating a video output data stream, to a method for outputting a video source data stream. Further embodiments relate to a computer program.

### BRIEF DESCRIPTION OF THE DRAWINGS

Embodiments of the present invention will be detailed subsequently referring to the appended drawings, in which:

FIG. 1 shows a schematic block circuit diagram of a video system comprising a device for generating a video output data stream, a first video source and a second video source in accordance with an embodiment;

FIGS. 2a-d are schematic illustrations of video sources implemented as cameras at different points in time relative to a switching point in time of the device for generating the video output data stream in accordance with an embodiment, wherein:

FIG. 2a illustrates a point in time when no transition effect is applied;

FIG. 2b illustrates a point in time when the first video source represents a first transition effect and the video output stream comprises the transition effect;

FIG. 2c illustrates a point in time when the second video source represents a second transition effect, the device for generating the video output stream has switched and the video output stream comprises the transition effect;

FIG. 2d illustrates a point in time when the first and the second transition effect are finished; and

FIG. 3 shows a schematic comparison of the video source data streams and the video output data stream in accordance with an embodiment while referring to the figures.

### DETAILED DESCRIPTION OF THE INVENTION

Before embodiments of the present invention will be discussed below in greater detail referring to the drawings, it is pointed out that identical elements, objects and/or structures or those of equal function or equal effect, in the different figures, are provided with equal reference numerals so that the description of these elements illustrated in different embodiments is mutually exchangeable or mutually applicable.

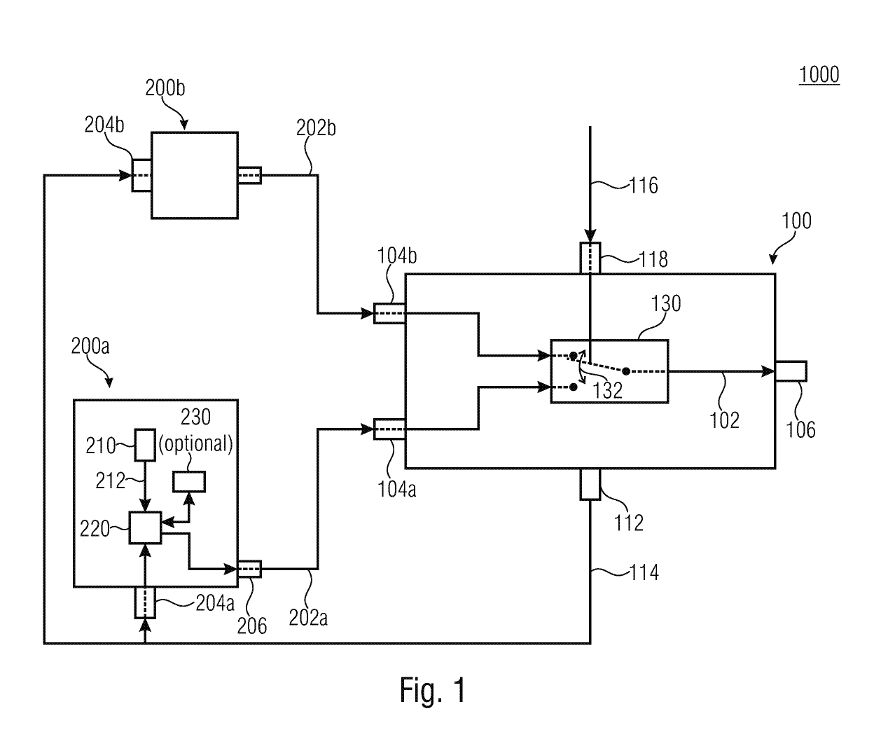

FIG. 1 shows a schematic block circuit diagram of a video system 1000 comprising a device 100 for generating a video output data stream 102, a first video source 200a and a second video source 200b. The video source 200a and 200b may exemplarily be a camera or a storage medium configured to output a video source data stream 202a and 202b. The video source data streams 202a and/or 202b may exemplarily be unencrypted, uncompressed, encrypted or encoded video signals. Advantageously, the video source data streams 202a and 202b are encoded, that is compressed, video signals.

Subsequently, at first reference is made to the structure and the mode of functioning of the device 100. After that, the structure and the mode of functioning of the video sources 200a and 200b will be explained.

The device 100 comprises a first signal input 104a for receiving the (first) video source data stream 202a and a second signal input 104b for receiving the (second) video source data stream 202b. In addition, the device 100 comprises a signal output 106 for outputting the video output data stream 102, for example to a medium or distributor network and/or a (video) replay apparatus.

The device 100 comprises a control signal output 112 for transmitting a control command 114 to the video sources 200a and/or 200b. The control command comprises an instruction to the video source 200a and 200b for applying a transition effect which is reproduced or is to be reproduced in the video output data stream 102.

The device 100 comprises processor means 130 configured to generate and/or provide the video output data stream 102. The processor means 130 is configured to switch between the video source data streams 202a and 202b for generating the video output data stream 102, so that the video output data stream 102 is defined by the video source data stream 202a at a first point in time and by the video source data stream 202b at a second point in time, for example. Switching may be done between two consecutive points in time, which is also referred to as hard switching. Expressed in a simplified manner, the processor means 130 is configured to pass on either the video source data stream 202a or the video source data stream 202b functioning as a switch or splitter and provide same as the video output data stream 102. The device 100 may pass on a respective video source signal 202a or 202b in a time-selective manner, without decoding, changing and encoding the respective signal, that is without manipulating the signal.

Furthermore, the processor means 130 may be configured to encode the respective video source data stream 202a or 202b to be passed on and encode same further, that is beyond an extent used up to then, in order to allow compatibility of the video output data stream 102 with a communication protocol, like TCP/IP (Transmission Control Protocol/Internet Protocol), WLAN (Wireless Local Area Network) and/or a wired communication protocol, for example. In addition, encoding may also take place such that the video output data stream 102 may be stored in a file format.

Switching 123 between the video source data streams 202a and 202b may be triggered by means of a user input 116 which is received by the device 100 at a user interface 118 and passed on to the processor means 130, that is provided to it. The user interface 118 may, for example, be a wired interface, like when switching 132 is triggered based on pressing a button at the device 100 or an input apparatus thereof. Alternatively, the user interface 118 may be a wireless interface, like when receiving the user input 116 wirelessly, for example by a wireless remote control.

During the switching process, that is in a time interval before the switching point in time and/or in a time interval after the switching point in time, it may be desirable to integrate a transition effect in the video output data stream 102. The transition effect may exemplarily comprise fading in, fading out, a variation of individual or several color intensities or a contrast and/or fading over the signal or sequence of images provided by the video source with graphics or an image. Alternatively or additionally, the transition effect may comprise a deterministic or stochastic mapping function, like a distortion of the image output, a (pseudo-)random change of the image and/or a mosaic effect.

The device 100 is configured to configure the control command 114 correspondingly so that the control command comprises an instruction instructing a video source 200a and/or 200b received to integrate a corresponding transition effect at least partly into the video source data stream 202a and/or 202b provided by it.

The device 100 may, for example, be implemented as a video mixer. Alternatively or additionally, the device 100 may be implemented as a personal computer (PC) or as a mobile device, like a mobile phone or a tablet computer. The first and second signal inputs 104a and 104b may also be united to form a common interface, like a network or wireless interface.

Subsequently, the mode of functioning of the video sources 200a and 200b will be explained.

The video sources 200a and 200b comprise a signal input 204a and 204b, respectively, where the video source 200a and 200b receives the control command 114. The video source 200a comprises a device 210 for providing a sequence 212 of images, like a camera chip or a data storage onto which are stored a plurality of images and which is configured to retrieve the sequence 212 with a plurality of images. The video source 200a additionally comprises processor means 220 configured to receive a sequence 212 of images from the device 210 and to at least partly superimpose these with the transition effect. This will subsequently be referred to as superimposing the video information by the transition effect.

The processor means 220 is additionally configured to generate and/or provide the video source signal 202a. The processor means 220 may be a processor of the video source, like a central processing unit (CPU), a microcontroller, a field-programmable gate array (FPGA) or the like. The video source 200a is configured to output the video source data stream 202a based on the transition effect, or the video source data stream 202a comprises the transition effect when applying the superimposing effect. Alternatively or additionally, the video source may be configured to apply the transition effect based on an intervention in a hardware-accelerated image signal processor (ISP) and/or based on image processing by means of graphical processor means. This allows realizing the transition effect within a small time interval and/or a small number of calculating operations.

The video source 200 comprises an output interface 206 configured to transmit the video source signal 202a. Transmitting may be wire-bound, like by means of a network or a direct cable connection to the device 100. Alternatively, the transfer may also be wireless. In other words, the signal inputs 104a, 104b, 112, 204a, 204b and/or 206 may be implemented to be wired or wireless interfaces.

The video source 200 comprises an optional graphics memory 230 configured to store a graphic and provide same to the processor means 220. The graphic may exemplarily be a logo or a continuous or constant image effect which is at least occasionally superimposed by images provided by the device 210. Alternatively, the video source 200a and/or 200b may be configured to receive corresponding graphics from another device, like a computer, or from the device 100. This may, for example, take place by means of a separate or already existing transfer channel, like a channel on which the control command 114 is transferred.

The video sources 200a and 200b may, for example, be implemented as two cameras which detect an equal or mutually different object regions, like the same (maybe from different view angles) or different (sports) events or other recordings, like person and/or landscape sceneries. Alternatively or additionally, at least one of the video sources 200a or 200b may be implemented to be a video memory, like a hard disk drive. Alternatively, the video system 1000 may comprise further video sources.

After having described the functionality of the individual component of the video system 1000 in the above expositions, the functionality of the video system, that is the cooperation of the individual components, will be explained below.

A transition effect may be desired in one or several transitions from the video source data stream 202a to the video source data stream 202b, or vice versa, for example by a user. The corresponding use input 116 may, for example, be received by means of the interface 118. Information relating to the transition effect is transmitted to the respective or all the video sources 200a and/or 200b concerned by means of the control command 114. Expressed in a simplified manner, the device 100 provides information on which switching effect is to be performed at which points in time. The information may, for example, relate to an identification, like a number or an index of the transition effect, to a duration of the transition effect, to a starting point in time, to a final point in time, to a type or intensity of the transition effect. The control command 114 may be transmitted specifically to a video source 200a or 200b or be transmitted to all the participants by means of a broadcast so that the respective receiver, that is the video source 200a or 200b, recognizes that the message is determined for it.

If the desired transition effect comprises a manipulation or amendment of the video source data streams 202a and 202b of both video sources 200a and 200b concerned, this transition effect may be subdivided into two or several sub-effects. At least one sub-effect may be applied to the sequence of images 212 of the respective video source 200a and/or 200b. Exemplarily, a transition effect (maybe referred to as soft) from a first to a second video source data stream may be a fade-out effect of the first data stream and a fade-in effect of the second data stream. This transition effect may be represented as a first transition sub-effect (fade-out effect) and second transition sub-effect (fade-in effect). One respective sub-transition effect may be applied by one of the video sources 200a and/or 200b. Exemplarily, a fade-out of a video source data stream 202a provided at a point in time as the video output data stream 102 and fade-in of a video source data stream 202b contained subsequently in the video output data stream 102 may be realized by fading out in the video source 200a and by fading in the video source 200b. Alternatively, the transition effect may also be realized only in one video source data stream, for example fading out or fading away or only fading in.

The processor means 130 of the devices 100 and 220 of the video sources 200a and/or 200b may be synchronized temporally among each other so that a temporally matching positioning of the individual transition effects may be set. A temporal synchronization may, for example, be obtained by means of a further transfer channel on or in which the control command 114 is transmitted, by means of a transfer channel in which the video source data streams 202a and/or 202b are transferred and/or by a common synchronization signal which is received by the device 100 and/or by the video sources 200a and/or 200b on other channels. This allows omitting additional synchronization of the video streams 202a and 202b each with and without transition effects by the device 100.

The video sources 200a and/or 200b may additionally be configured to output the respective video source data stream 202a and/or 202b at a variable bit rate. Exemplarily, it may be sufficient for the video source(s), the video source data stream of which is not inserted into the output data stream 102 at present, to transmit only (video) information at low quality, that is bit rate, and to transmit a bit rate of the video source, for example, the video source data stream of which is integrated in the video output stream, at an equal or higher bit rate and/or quality. This may, in particular, be of advantage with a commonly used transfer medium, for example a common radio medium or a common wired network.

Exemplarily, the respective video source 200a or 200b passed on may generate video signals 202a and/or 202b at a high or maximum bit rate, whereas a thumbnail view or an illustration at a low resolution of the video source data streams not used at present is sufficient for the operator using the device 100 or initiating the transition effect and/or looking at the video source data streams 202a and/or 202b in order to assess whether switching is to take place. The respective video source may be directed by the control command 114 or another message to change the bit rate of the respective video source data stream to a predetermined value or a value contained in the message. Alternatively, the video source may also be configured to automatically change the bit rate, for example in order to reduce the bit rate after having finished the fade-out effect and/or to increase the bit rate from a reduced value before or simultaneously with the onset of a fade-in effect.

In other words, one basic idea is that producing transition effects is left to be done by the cameras. Thus, the requirements to the video mixer, that is the device for generating the video output data stream, are reduced considerably. It may, for example, only to be able to accept ingoing video streams of one or several cameras, for example in an encoded form, and output one of the streams as an output video stream. In addition, the video mixer may be able to indicate the ingoing video streams, like on a monitor, or provide the video streams to a monitor. Thus, the video mixer may, for example, be able to perform decoding of the video streams. Alternatively, decoding may also take place in the monitor. Thus, re-coding of the video data is not necessary. Additionally, a prerequisite or further development may be for the cameras and the video mixer to have a common time base, that is to be synchronized. A way of communicating between the video mixer and the cameras attached (back channel) may also be necessitated. Switching may either take place in a hard manner or a transition effect may be produced. A hard cut may be when a stream S1 is used as the output stream before a switching point in time T and the video stream S2 becomes the output stream at the time T.

It is of advantage for applying switching effects to take place in real time directly on the camera, with no post production (post-processing) or expensive mixer hardware. In addition, additional time delays caused by applying effects may be prevented from forming if calculating the partial video effect is performed in corresponding components of the video sources. This may, for example, be achieved by integrating the calculation of the partial video effect into a hardware-accelerated image processing chain of the camera. This also allows realizing the concept described without arranging additional hardware resources for producing video effects on the part of the camera. In addition, no additional hardware resources are necessitated for producing video effects on the part of the video mixer. No recoding of the video data received is necessitated. A minimum time delay caused by adding the transition effect may be obtained if the partial transition effect is processed by graphical processor means.

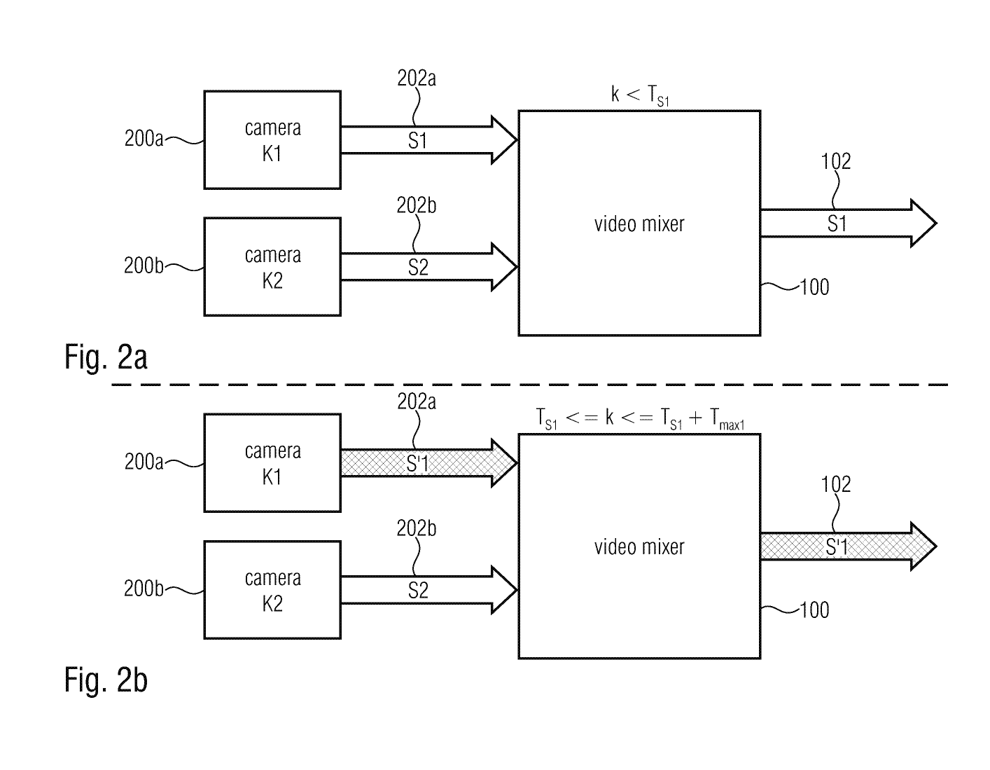

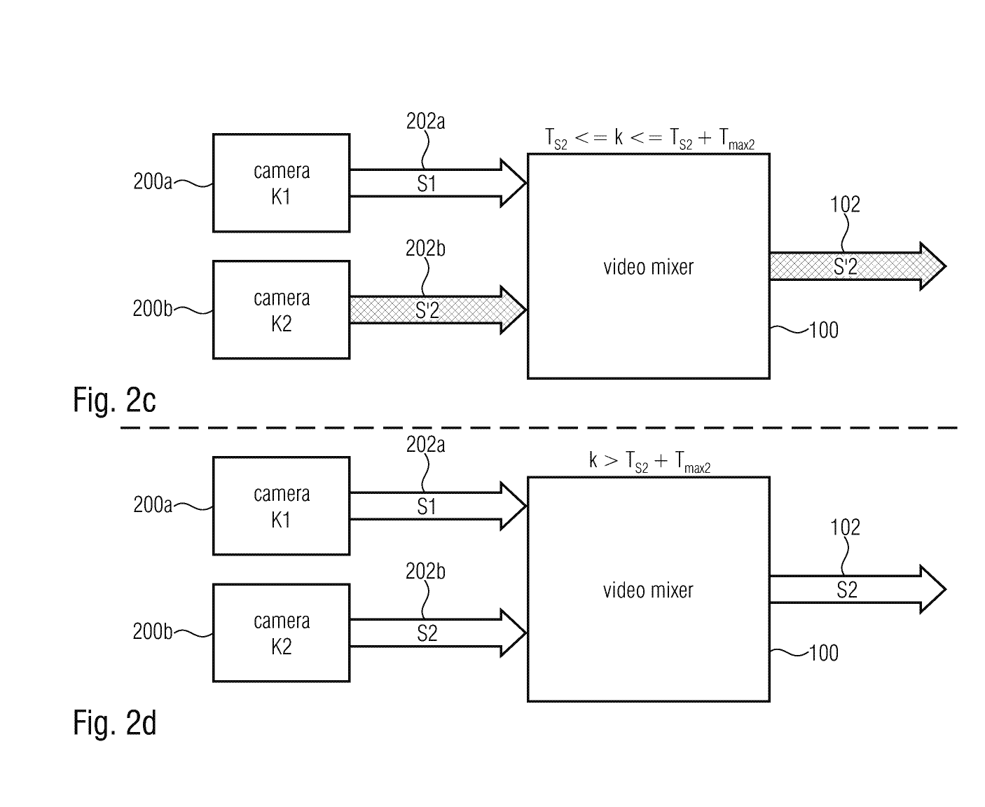

FIGS. 2a-d show schematic illustrations of the video sources 200a and 200b, implemented as cameras, at different points in time relative to a switching point in time. The video sources 200a and 200b each transmit the video source data stream 202a and 202b, respectively, to the device 100 (video mixer). In addition, FIGS. 2a-d show a content of the video output data stream 102.

FIG. 2a schematically shows, at points in time k<T_{S1}, that the video source 200a makes available to the device 100 the video source data stream 202a termed S1 and the video source 200b the video source data stream 202b termed S2. The device 100 generates the video output data stream 102 based on the video source data stream 202a, or provides same. T_{S1} relates to a starting point in time of a transition (sub-)effect of a duration of Tₘₐₓ₁ applied by the video source 200a. The points in time k illustrated are before the beginning of an illustration of the transition effect in one of the data streams 202a or 202b, which is described by “k<T_{S1}”. At the point in time T_{S1}, until a point in time k=T_{S1}+Tₘₐₓ₁, a transition effect is applied to the video source data stream 202a, resulting in a modified video source data stream S′1.

As is illustrated in FIG. 2b and indicated by the term S′1, the video source 200a provides the modified video source data stream S′1 at points in time k greater than or equaling the point in time T_{S1} and smaller than or equaling T_{S1}+Tₘₐₓ₁. This results in a transition effect contained in the video output data stream 102, as is indicated by the term S′1 in the video output data stream 102.

FIG. 2c schematically shows the video output data stream 102 after the switching process. The video source 200b is configured to implement, starting at a point in time T_{S2} for a duration Tₘₐₓ₂, a (partial) transition effect in the video source data stream 202b and output the video source data stream 202b modified in this way, which is indicated by the term S′2. The video mixer or device 100 is thus configured such that the video output data stream 102 is generated, or provided, based on the video source data stream 202b. This means that, at the point in time T_{S2}, in contrast to the situation illustrated in FIG. 2b, the device 100 has switched from the video source data stream 202a to the video source data stream 202b in order to output same.

After the end of the transition effect in the video source data stream 202b, that is at points in time k>T_{S2}+Tₘₐₓ₂, and as is illustrated schematically in FIG. 2d, the superimposing of the stream S2 by the superimposing effect ends so that the video source 200b provides the (unmodified) stream S2. The video source 200b provides the video source data stream 202b (S2) not superimposed or modified by a transition effect, which results, with an unamended configuration of the device 100, in the video output data stream 102 which is provided based on the video source data stream 202b.

Alternatively, the device 100 may also be configured to switch between the video source data streams 202a and 202b at a different point in time when the video source data stream 202a and/or 202b comprises a transition (sub-)effect. Exemplarily, when only one of the video sources 200a or 200b applies a transition effect, switching may take place during the duration of this effect. Switching may take place at the beginning of, at the end of or during a duration of the transition (sub-)effect, like when total fading out of the first video source data stream 202a is not required nor desired.

When switching is to take place with a transition effect, a respective message is sent to the video sources (cameras) K1 and K2, which describes the partial transition effect, like, for example, the type of the effect, for example fade-in, fade-out, length of the effect Tₘₐₓ and/or the starting or final point in time of the respective partial effect. The starting point in time in the respective video source may be established from the final point in time and the duration of the effect.

At the starting point in time of the effect, a routine which has an effect on the image processing (maybe in real time) may be started on the camera. Generally, this routine may also be defined as a map f(k):

f(k): Bk→B′k, T_{S}≦k≦T_{S}+Tₘₐₓ

which maps the image Bk taken or reproduced at the point in time k, onto the image B′k. A special map fᵢ(k) may be defined for every partial effect i possible. The map may, for example, comprise a distortion, mosaic effects or any other (sub-)effects.

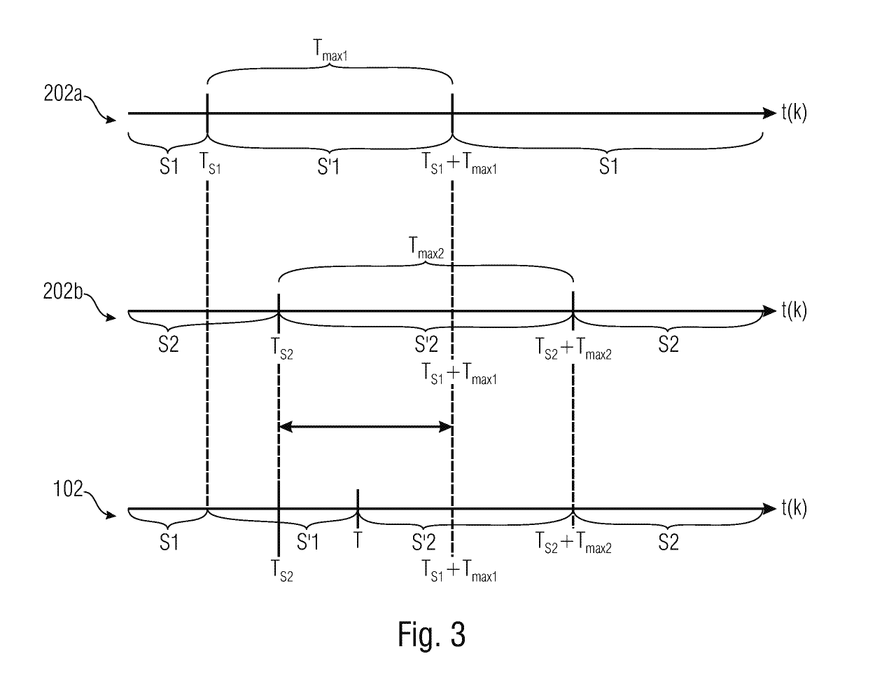

FIG. 3 shows a schematic comparison between the video source data streams 202a and 202b and the video output data stream 102 while referring to FIGS. 2a-d. The signals 202a, 202b and 102 are synchronized, which means that they comprise the same time base. Exemplarily, one (sub-)image each is reproduced in each of the video source data streams 202a and 202b at any point in time k.

At a point in time k=T_{S1}, superimposing of the video source data stream 202a by a transition effect starts, with a duration Tₘₐₓ₁. The transition effect ends at a point in time k=T_{S1}+Tₘₐₓ₁. At points in time T_{S1}≦k≦T_{S1}+Tₘₐₓ₁, the modified video source data stream S′1 is received by the device 100. At a point in time k=T_{S2}, superimposing of the video source data stream 202b by a transition effect begins, which comprises a duration of Tₘₐₓ₂ and lasts to a point in time T_{S2}+Tₘₐₓ₂. At points in time T_{S2}≦k≦T_{S2}+Tₘₐₓ₂, the modified video source data stream S′2 is received by the device 100.

The durations Tₘₐₓ₁ and Tₘₐₓ₂ may be equal or mutually different and be based on the respective transition effect or transition sub-effect. At a point in time T, the video mixer switches so that, before the point in time T, the video output data stream 102 is based on the video source data stream 202a and, starting from the point in time T, on the video source data stream 202b.

The point in time k=T is arranged such that it is temporally at or after the point in time T_{S2} and at or before the point in time T_{S1}+Tₘₐₓ₁. Exemplarily, the point in time T_{S2} corresponds to the point in time T_{S1}+Tₘₐₓ₁ so that the point in time T coincides with both points in time (T_{S1}+Tₘₐₓ₁ and T_{S2}). The temporal course of the video output signal 102 before the point in time T_{S1} corresponds to the situation as is illustrated in FIG. 2a. The situation starting from the point in time T_{S1} until the point in time T in analogy corresponds to the situation of FIG. 2b. Starting at the point in time T until the point in time T_{S2}+Tₘₐₓ₂, the situation is illustrated exemplarily in FIG. 2c. The situation for subsequent points in time, that is after the transition effect of the video source 202 has ended, is illustrated in FIG. 2d.

In other words, FIGS. 2a-d and 3 show the entire course of generating a distributed transition effect. Before the point in time T_{S1}, the unamended video stream S1 is output by the video mixer.

At the points in time k, with T_{S1}≦k≦T_{S1}+Tₘₐₓ₁, the video stream on the camera K1 is influenced by the map f₁(k) and is termed S′1.

At the point in time k=T (T_{S2}, for example), with T≦T_{S1}+Tₘₐₓ₁, that is the transition effect of the video source 200a has not ended yet, the video mixer switches the output stream to the output of the camera K2. At the points in time k, with T≦k≦T_{S2}+Tₘₐₓ₂, the video stream on the camera K2 is influenced by the map f₂(k) and is termed S′2.

Starting at the point in time k=T_{S2}+Tₘₐₓ₂+1, the unamended video stream S2 is output by the video mixer. Thus, generating the transition effect has ended.

The concept suggested allows implementing desired cheap, mobile real time-capable video mixers which, if desired by the operator (user), may generate simple switching effects.

These may, for example, be applied in mobile live video content production systems having several cameras which use a cell phone or a computer, a tablet PC or the like as a video mixer.

Although the previous embodiments related to a video mixer comprising processor means, embodiments of the present invention may also be implemented as a program code or software.

Although some aspects have been described in the context of a device, it is clear that these aspects also represent a description of the corresponding method, such that a block or element of a device also corresponds to a respective method step or a feature of a method step. Analogously, aspects described in the context of or as a method step also represent a description of a corresponding block or item or feature of a corresponding device.

Depending on certain implementation requirements, embodiments of the invention may be implemented in hardware or in software. The implementation may be performed using a digital storage medium, for example a floppy disk, a DVD, a Blu-Ray disc, a CD, an ROM, a PROM, an EPROM, an EEPROM or a FLASH memory, a hard drive or another magnetic or optical memory having electronically readable control signals stored thereon, which cooperate or are capable of cooperating with a programmable computer system such that the respective method is performed. Therefore, the digital storage medium may be computer readable. Some embodiments according to the invention include a data carrier comprising electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine-readable carrier.

Other embodiments comprise the computer program for performing one of the methods described herein, wherein the computer program is stored on a machine-readable carrier.

In other words, an embodiment of the inventive method is, therefore, a computer program comprising a program code for performing one of the methods described herein, when the computer program runs on a computer. A further embodiment of the inventive methods is, therefore, a data carrier (or a digital storage medium or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field-programmable gate array, FPGA) may be used to perform some or all of the functionalities of the methods described herein. In some embodiments, a field-programmable gate array may cooperate with a microprocessor in order to perform one of the methods described herein. Generally, in some embodiments, the methods may be performed by any hardware apparatus. This can be a universally applicable hardware, such as a computer processor (CPU) or hardware specific for the method, such as ASIC.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### LITERATURE

[1] R. a. C. F. Kurceren, “Compressed Domain Video Editing,” in Acoustics, Speech and Signal Processing, 2006. ICASSP 2006 Proceedings. 2006 IEEE International Conference on, 2006.

[2] W. A. C. Fernando, C. C. N. and D. Bull, “Video special effects editing in MPEG-2 compressed video,” in Circuits and Systems, 2000. Proceedings, ISCAP 2000 Geneva. The 2000 IEEE International Symposium on, Geneva, 2000.

1. A device for generating a video output data stream, comprising:
a first signal input for receiving a first video source data stream;
a second signal input for receiving a second video source data stream;
a processor configured to provide the video output data stream based on the first video source data stream at a first point in time and, by means of a switching process, based on the second video source data stream at a second point in time which follows the first point in time;
a control signal output for transmitting a control command to a video source from which the first or second video source data stream is received;
wherein the control command comprises an instruction to the video source for applying a transition effect which is temporally located between an image of the first and an image of the second video source data stream in the video output signal, and wherein the video source data stream received from the video source comprises the transition effect at least partly;
wherein the transition effect is a map, a fade-in effect, a fade-out effect or an effect for fading over a first image of the video source data stream by a second image of the video source data stream or by graphics stored in a graphics memory or received by the video source.

2. The device in accordance with claim 1, wherein the instruction relates to at least one of a duration, a starting point in time, a final point in time, a map, a type or intensity of the transition effect.

3. The device in accordance with claim 1, wherein the transition effect is configured to be applied by the video source to the first or second video source data stream in a time interval when the processor executes the switching process.

4. The device in accordance with claim 1, wherein the processor is configured to process program code in a time-synchronous manner with a processor of the video source.

5. The device in accordance with claim 1, wherein the processor is configured to configure the instruction based on a user input.

6. The device in accordance with claim 1, wherein the transition effect comprises a first sub-effect and a second sub-effect, wherein the device is configured to transmit a first control command comprising a first instruction for applying the first sub-effect to the first video source and to transmit a second control command comprising a second instruction for applying the second sub-effect to the second video source.

7. The device in accordance with claim 1, further configured to provide the first or second video source data stream with the transition effect as the video output data stream, without manipulating the first or second video source data stream.

8. A video source configured to output a video source data stream, comprising:
a signal input for receiving a control command from a device for generating a video output stream, which comprises an instruction for applying a transition effect to the video source data stream;
wherein the instruction refers to at least one of a duration, a starting point in time, a final point in time, a type or intensity of the transition effect;
wherein the video source is configured to implement the transition effect in the video source data stream based on the control command and to output a modified video source data stream; and
wherein the transition effect is a map, a fade-in effect, a fade-out effect or an effect for fading over a first image of the video source data stream by a second image of the video source data stream or by graphics stored in a graphics memory or received by the video source;
wherein the video source is configured to output the video source data stream based on an image sensor of the video source or retrieve same from a data storage of the video source.

9. The video source in accordance with claim 8, configured to superimpose video information by the transition effect.

10. The video source in accordance with claim 8, configured to output the video source data stream comprising the transition effect.

11. The video source in accordance with claim 8, wherein the transition effect is a map, a fade-in effect, a fade-out effect or an effect for superimposing a first image of the video source data stream by a second image of the video source data stream or by graphics stored in a graphics memory of the video source or received by a device.

12. The video source in accordance with claim 8, further comprising a processor configured to process a program code in a time-synchronous manner with a processor of a device for generating a video output data stream.

13. The video source in accordance with claim 8, configured to apply the transition effect based on influencing the image signal processing chain or based on a graphical processor.

14. The video source in accordance with claim 8, configured to output the video source data stream at a changeable bit rate.

15. A video system comprising:
a device for generating a video output data stream, comprising:
a first signal input for receiving a first video source data stream;
a second signal input for receiving a second video source data stream;
a processor configured to provide the video output data stream based on the first video source data stream at a first point in time and, by means of a switching process, based on the second video source data stream at a second point in time which follows the first point in time;
a control signal output for transmitting a control command to a video source from which the first or second video source data stream is received;
wherein the control command comprises an instruction to the video source for applying a transition effect which is temporally located between an image of the first and an image of the second video source data stream in the video output signal, and wherein the video source data stream received from the video source comprises the transition effect at least partly;
wherein the transition effect is a map, a fade-in effect, a fade-out effect or an effect for fading over a first image of the video source data stream by a second image of the video source data stream or by graphics stored in a graphics memory or received by the video source;
a first video source; and
a second video source,
wherein the first and second video sources configured to output a video source data stream each comprise:
a signal input for receiving a control command from a device for generating a video output stream, which comprises an instruction for applying a transition effect to the video source data stream;
wherein the instruction refers to at least one of a duration, a starting point in time, a final point in time, a type or intensity of the transition effect;
wherein the video source is configured to implement the transition effect in the video source data stream based on the control command and to output a modified video source data stream; and
wherein the transition effect is a map, a fade-in effect, a fade-out effect or an effect for fading over a first image of the video source data stream by a second image of the video source data stream or by graphics stored in a graphics memory or received by the video source;
wherein the video source is configured to output the video source data stream based on an image sensor of the video source or retrieve same from a data storage of the video source.

16. The video system in accordance with claim 15, wherein the transition effect comprises a first sub-effect and a second sub-effect, wherein the device for generating a video output data stream is configured to transmit a first control command comprising a first instruction for applying the first sub-effect to the first video source and to transmit a second control command comprising a second instruction for applying the second sub-effect to the second video source.

17. A method for generating a video output data stream, comprising:
receiving a first video source data stream;
receiving a second video source data stream;
providing the video output data stream based on the first video source data stream at a first point in time and, by means of a switching process, based on the second video source data stream at a second point in time which follows the first point in time;
transmitting a control command to the video source from which the first or second video source data stream is received;
wherein the control command comprises an instruction to the video source for applying a transition effect to the first or second video source data stream, wherein the video source data stream received from the video source comprises the transition effect; and
wherein the instruction relates to at least one of a duration, a starting point in time, a final point in time, a map, a type or intensity of the transition effect; and
wherein the transition effect is a map, a fade-in effect, a fade-out effect or an effect for fading over a first image of the video source data stream by a second image of the video source data stream or by graphics stored in a graphics memory or received by the video source.

18. A method for outputting a video source data stream by a video source, comprising:
providing the video source data stream based on an image sensor of the video source or based on retrieving from a data storage of the video source;
receiving a control command comprising an instruction for applying a transition effect to the video source data stream;
implementing the transition effect in the video source data stream based on the control command and outputting a modified video source data stream;
wherein the instruction relates to at least one of a duration, a starting point in time, a final point in time, a map, a type or intensity of the transition effect; and
wherein the transition effect is a map, a fade-in effect, a fade-out effect or an effect for fading over a first image of the video source data stream by a second image of the video source data stream or by graphics stored in a graphics memory or received by the video source.

19. A non-transitory digital storage medium having stored thereon a computer program for performing a method for generating a video output data stream, comprising:
receiving a first video source data stream;
receiving a second video source data stream;
providing the video output data stream based on the first video source data stream at a first point in time and, by means of a switching process, based on the second video source data stream at a second point in time which follows the first point in time;
transmitting a control command to the video source from which the first or second video source data stream is received;
wherein the control command comprises an instruction to the video source for applying a transition effect to the first or second video source data stream, wherein the video source data stream received from the video source comprises the transition effect; and
wherein the instruction relates to at least one of a duration, a starting point in time, a final point in time, a map, a type or intensity of the transition effect; and
wherein the transition effect is a map, a fade-in effect, a fade-out effect or an effect for fading over a first image of the video source data stream by a second image of the video source data stream or by graphics stored in a graphics memory or received by the video source,
when said computer program is run by a computer.

20. A non-transitory digital storage medium having stored thereon a computer program for performing a method for outputting a video source data stream by a video source, comprising:
providing the video source data stream based on an image sensor of the video source or based on retrieving from a data storage of the video source;
receiving a control command comprising an instruction for applying a transition effect to the video source data stream;
implementing the transition effect in the video source data stream based on the control command and outputting a modified video source data stream;
wherein the instruction relates to at least one of a duration, a starting point in time, a final point in time, a map, a type or intensity of the transition effect; and
wherein the transition effect is a map, a fade-in effect, a fade-out effect or an effect for fading over a first image of the video source data stream by a second image of the video source data stream or by graphics stored in a graphics memory or received by the video source,
when said computer program is run by a computer.
